(19) United States
(12) Patent Application Publication
(10) Pub. No.: US 2005/0127158 A1
(43) Pub. Date: Jun. 16, 2005

(54) Control card check

(76) Inventors: Ilka H. Figueras, Maimi, FL (US); Maximiliano Karltun Moreno, Van Nuys, CA (US); Patricia L. Lauriet-Moreno, Van Nuys, CA (US)

Correspondence Address: MAXIMILIANO K. MORENO;C/O ILKA H. FIGUERAS, 6448 BLEWETT AVE., VAN NUYS, CA, 91406, US

(21) Appl. No.: 10/734,983

(22) Filed: Dec. 15, 2003

(51) Int. Cl. G06F 17/60

(52) U.S. Cl. 235/379

(57) ABSTRACT

CONTROL CARD CHECK is a pocket size system and a method for auditing personal accounts. It is an individual module that operates on a digital level. This invention is for bank account and credit card information inspecting only. This technology system provides access to your bank and credit card information instantaneously, without having to log onto the Internet, drive to your bank (ATM), or call a service bank agent. This system will allow you to check your current balance on any account card you own, excluding gas cards, retail cards, and phone cards, just by inserting the card into the card reader. The design of the pocket electro mechanism is slightly larger than your account card with a magnet strip-card reader embedded to the back of the instrument. In seconds, see your balance by entering your four-digit security pin number on the touch screen. On the menu screen you will have four options to choose from. 1. Current balance. 2. Daily transactions. 3. Weekly transactions. 4. Payment information and Due date. (Bank payment address & phone numbers). Ideal for any situation

### CROSS-REFERENCE TO RELATED APPLICATIONS

| | | |
|---|---|---|
| July 1983 | Atalla, et al. | 705/70 |
| January 2001 | Mc George, Jr. | 707/6. |
| May 1998 | Krause | 235/492. |
| May 1998 | Thomas | 705/44. |
| April 1999 | Tramontano | 235/380 |

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The first ATM was installed 1969 by Chemical Bank at it's branch in Rockville Center, N.Y. America. Now, every bank in the world can do ATM's, and issue check cards and credit cards to their customers. Still today, no bank or credit card company has offered their clients with a new convenient way to assess their account balance with an accommodating tool. Today, more than ever before, because of the fast paced society and change, people are in need to audit their accounts faster in order to know if they are within or over their budgets, but banks have not satisfied this demand, causing customers to overlook receipts, make inaccurate check book reconciliation's, and resolving in overdraft charges. Everyone that owns an account card has experienced an inconvenience at one time or another when trying to retrieve his or her account data in the subsequent methods. The existing services that banks offer to check individual accounts are, calling the bank, visiting the institution (bank branch), and going on the Internet, which consumes time in order to retrieve account information. Not to mention, that many customers struggle on the Internet due to interposed unknowledgeable passwords and user ID names. Those systems and methods are past the prime, and discourage the average person. CONTROL CARD CHECK has the features that change all that, and helps you retrieve bank information at a speedy rate, anywhere, anytime.

The present invention is a system and a method for auditing financial accounts. This invention is classified under technology and pertains to the bank industry and credit card industry; but not limited to the cell phone communications industry, and PDA industry. CONTROL CARD CHECK is like walking around with your own personal automated teller machine (ATM) without a cash dispenser. CONTROL CARD CHECK is a device that can deliver information with the same speed of that from an ATM, but with the weight of a palm pilot. Both of who haven't been able to integrate in order to evolve a better personal access system until now. This Invention is an integration of technologies currently in use; Magnetoresistive, Credit card magnetic strip, wireless modem, microprocessor, host processor, and battery. This Idea is in demand by the millions of people that feel that bank services have come up short, and are inadequate when trying to audit personal accounts.

### DESCRIPTION OF THE PRIOR ART

Current technologies, such as cell phone and PDA (palm pilots) are practically interrupted; and it's uncommon that people access their accounts on cell phones via the Internet. Usually when people call their bank institutions, they experience break up problems due to reception disorder and pockets; and sometimes when making a call from a non-mobile connection, customers can wait for up to ten minutes to get a representative on the line, causing usage of free minutes or increasing prices in charged minutes.

Not to mention, PDA companies can't even offer this feature of calling in without the integration of the cell phone, as presented by SIEMENS MOBILE SX56, that's the latest integration technology. And still, that innovation comes up short as far as bank accessing is concerned. Why? Because people don't have the option to check each account card they own at the same time from the same device. CONTROL CARD CHECK offers comfort and security. For these reasons CONTROL CARD CHECK is an innovative technology integration that Cell Phone Companies and Palm PDA companies can also benefit from.

Banks such as WACHOVIA have a very limited and primitive way of informing their customers about their accounts. They have the use of delivering your account balance to your E-mail, Pager, or wireless pager device that the bank provides. It's a message device advising you when your account balance goes above or below the amount you specify. The problem with this device is that you would need more than one alerting pager if you bank with more than one bank. Imagine carrying around three pagers to access three different accounts. Not logical. Not to mention, WACHOVIA'S device can't even access credit card accounts, such as Capital One, Chase, TARGET, Citibank, AT&T, etc. This concludes that WACHOVIA'S new service for accessing account balance still come up short and is old when comparing it to CONTROL CARD CHECK'S dynamic feature that can access all your financial accounts in one system.

### SUMMARY OF THE INVENTION

A state of the art, transportable, digital wireless invention that relates to the use of a pocket size micro-controller to read data from/to a plurality of tracks contained on a magnetic stripe card; enabling the user to review his or hers personal financial records at a prompt rate, by inserting the card into a card reader that uses DSP, ADC, GSM, and ATM technologies, so people can have the freedom to employ the device from any location. This invention is the short cut to calling in, logging to the Internet, and driving to the bank institution. Now, people don't have to stress over following the old methods in order retrieve bank information. It's all in your pocket.

### BRIEF DESCRIPTION OF THE SEVERAL VIEWS OF THE DRAWINGS

The invention can be better understood with reference to the following drawings.

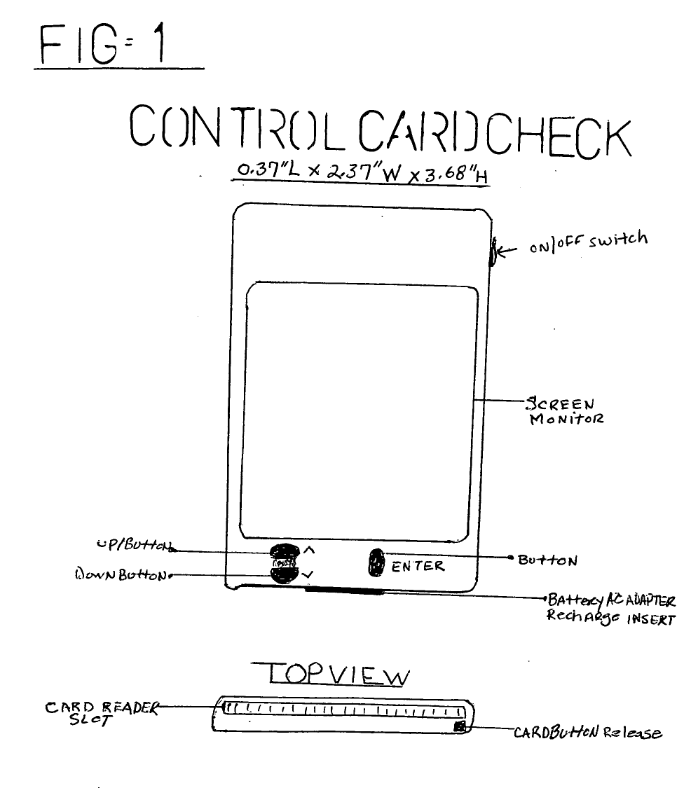

(FIG. 1) is an illustration of the CONTROL CARD CHECK embodiment. A digital, wireless system for accessing individual financial records. Dimensions: 0.37″L×2.37″W×3.68″H. Depicts the top view card reader slot for card insertion with release button. UP and DOWN buttons; ENTER button, battery recharge insert, and on/off switch.

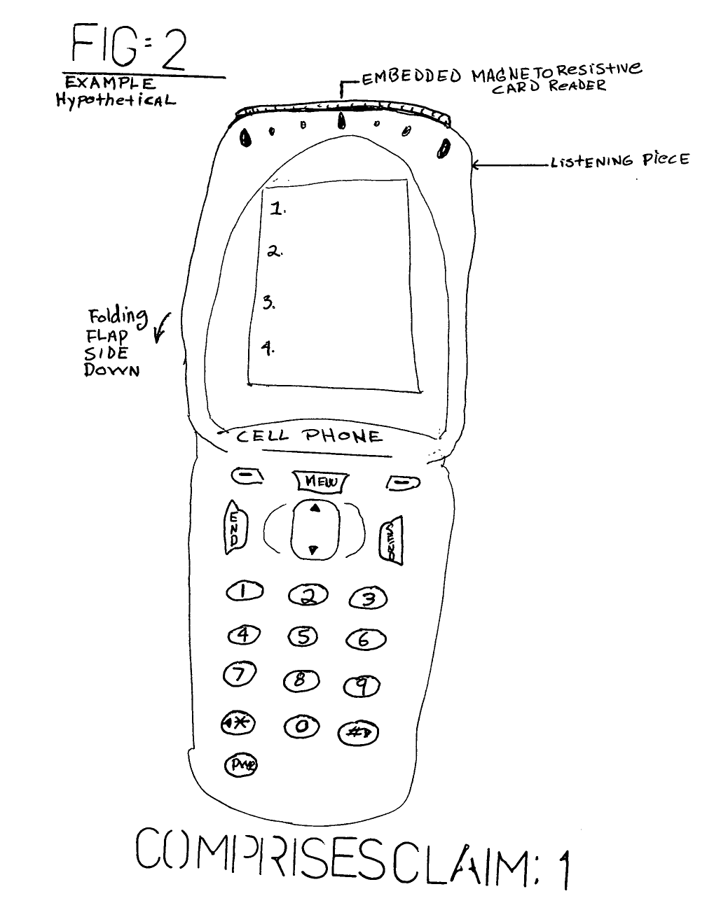

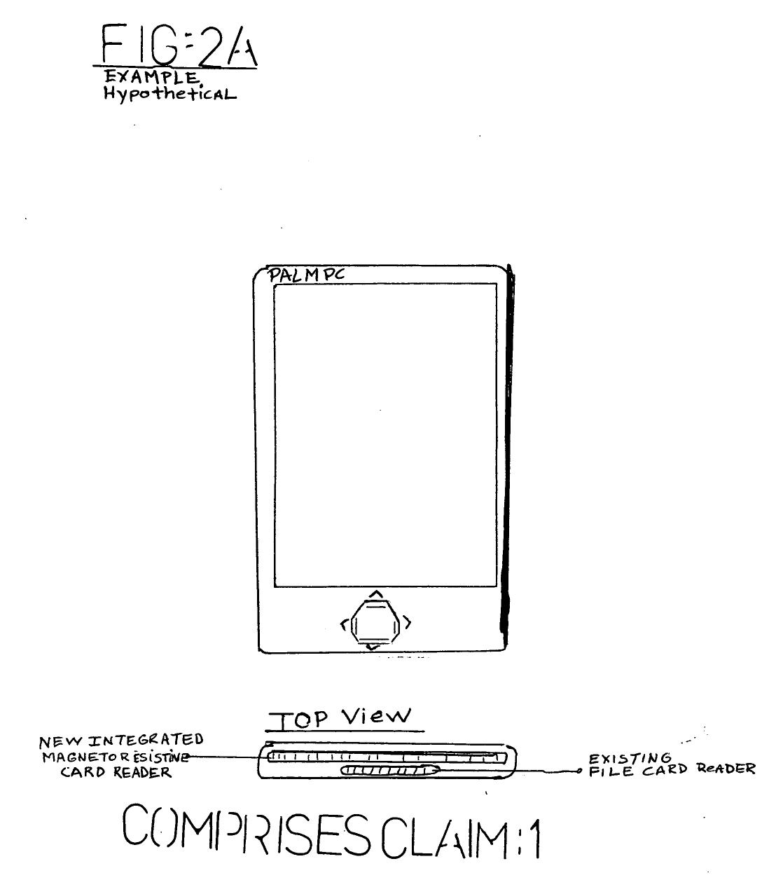

(FIG. 2) is an illustration of an embedded CONTROL CARD CHECK into a cell phone embodiment; Hypothetical example.

(FIG. 2A) is an illustration of an embedded CONTROL CARD CHECK into a pocket PC (PDA) embodiment; Hypothetical example shows the top view integration.

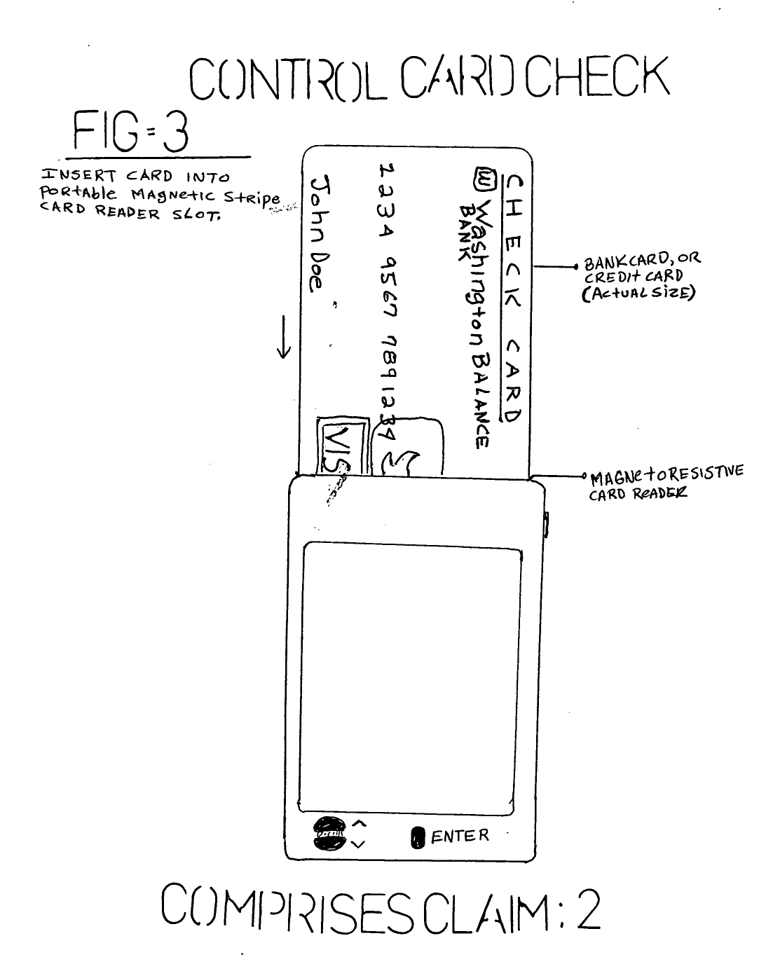

(FIG. 3) is an illustration of how the user inserts their card into the portable magnetic stripe card reader slot (magnetoresistive) operatively embedded inside the micro-controller.

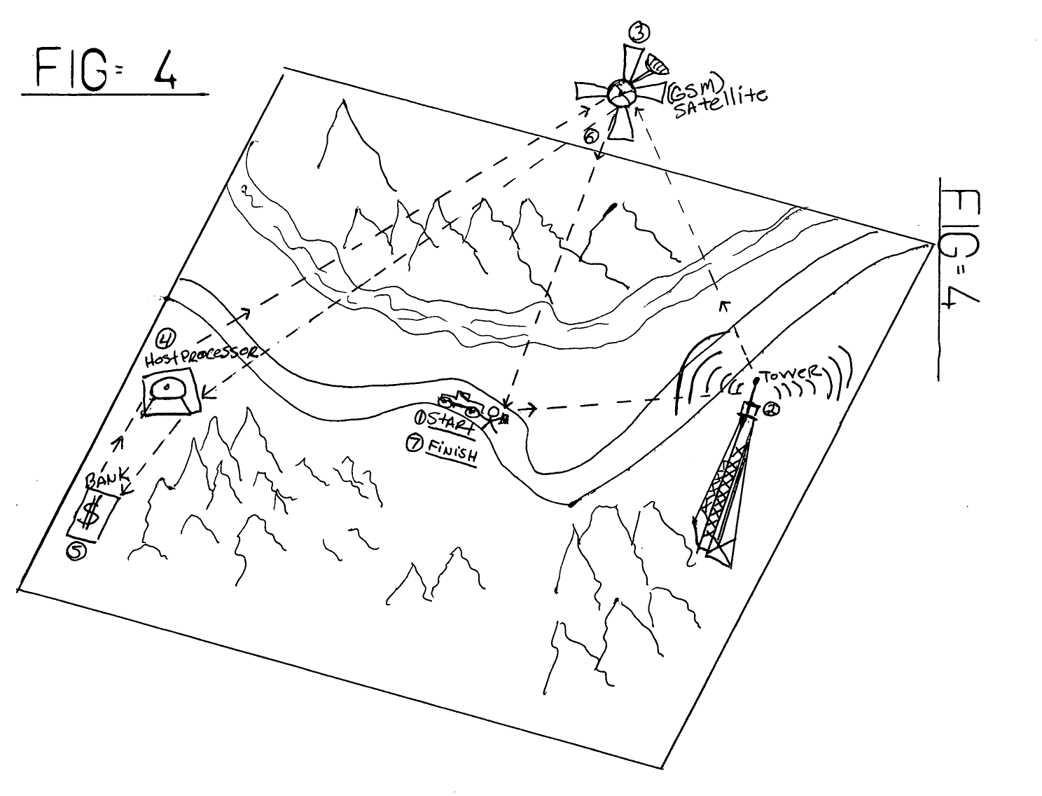

(FIG. 4) is a picture of how the frequency waves travel to achieve output transmission. Data from the CONTROL CARD CHECK is transmitted to a host processor using cell phone towers to find GSM satellites that send frequency to host processor, that unscrambles data, then sends reply back to satellite; satellite trunks that data to the CONTROL CARD CHECK.

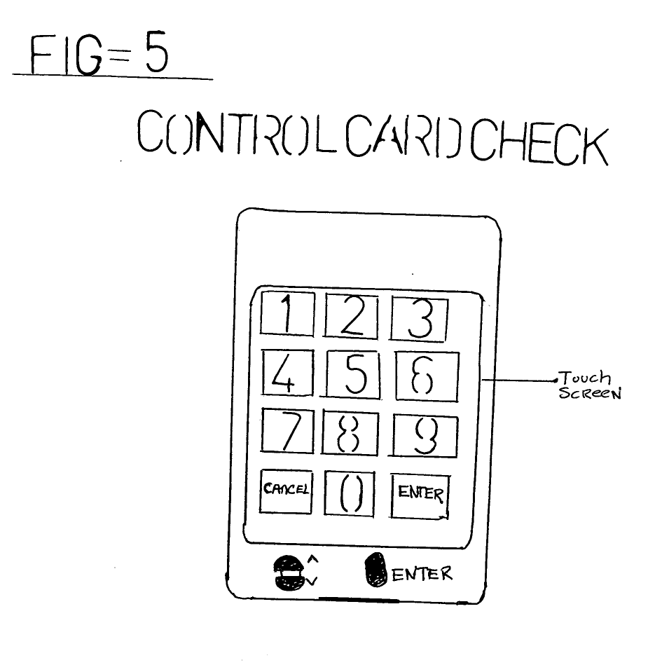

(FIG. 5) is an illustration that displays numbers on the touch screen for the user to input their four-digit pin number. Then touches ENTER to continue. If pin number is entered incorrectly, touch CANCEL and start over.

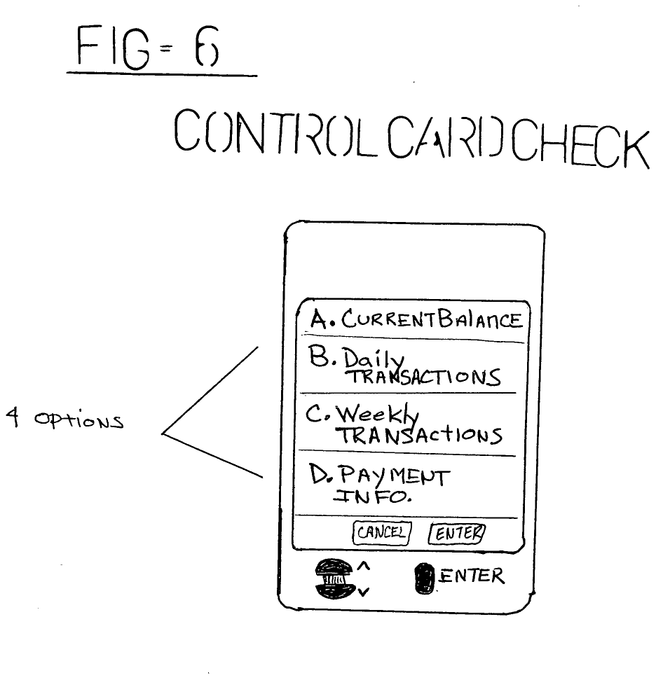

(FIG. 6) is an illustration of the device displaying the four options to choose from. Use left bottom button for up and down; or just touch the option, then press on button or touch ENTER to confirm option.

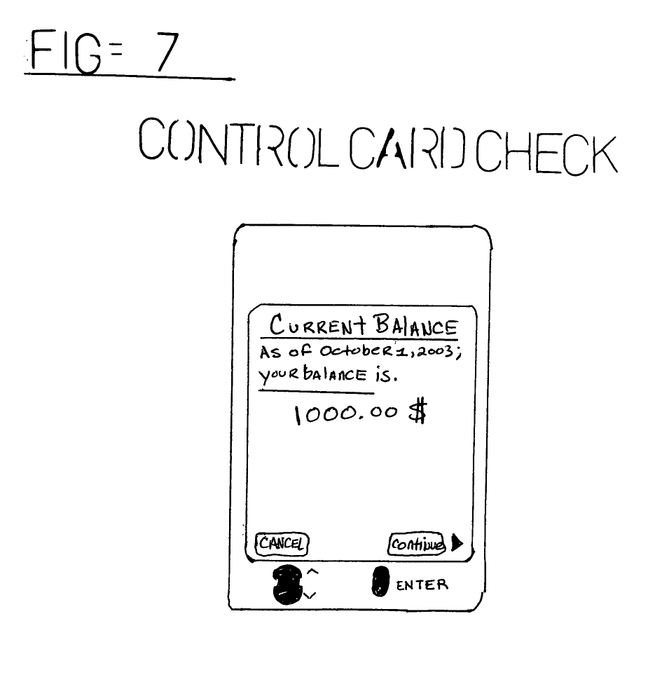

(FIG. 7) is an illustration of option A from FIG. 6; CURRENT BALANCE. Touch CANCEL at bottom left of the screen to cancel; touch CONTINUE at bottom right of the screen in order to move forward to choice B.

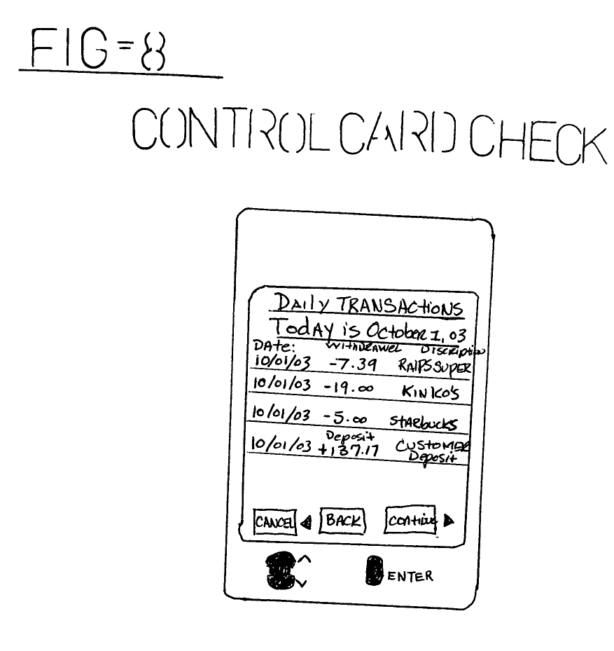

(FIG. 8) is a drawing of option B from FIG. 6; DAILY TRANSACTIONS. Use Up/Down button to move up or down on the display screen, or touch option on screen. Touch CANCEL at the bottom left of the screen to cancel. Touch BACK located at the middle bottom of the screen to move back to option A. Touch CONTINUE at bottom right of the screen to proceed to option C.

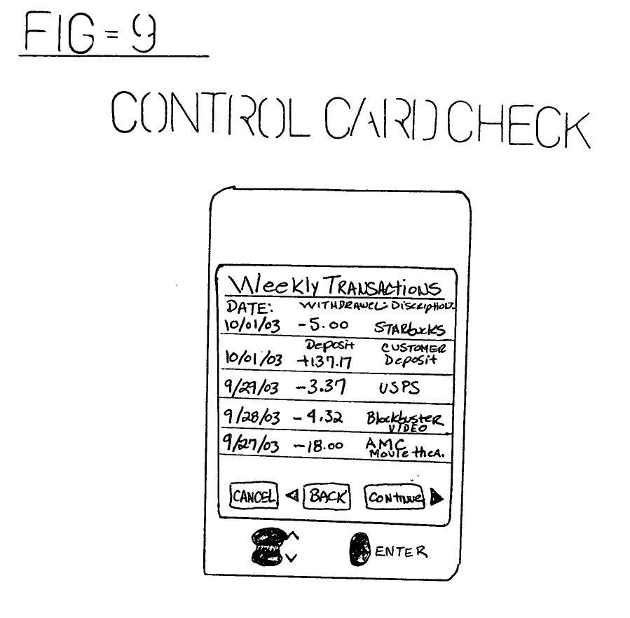

(FIG. 9) is an illustration of option C from FIG. 6; WEEKLY TRANSACTIONS. Use Up/Down button to move up or down on the display screen, or touch option on screen. Touch CANCEL at the bottom left of the screen to cancel. Touch BACK at middle bottom of the screen to move back to option B. Touch CONTINUE at the bottom left of the screen to move forward to option D.

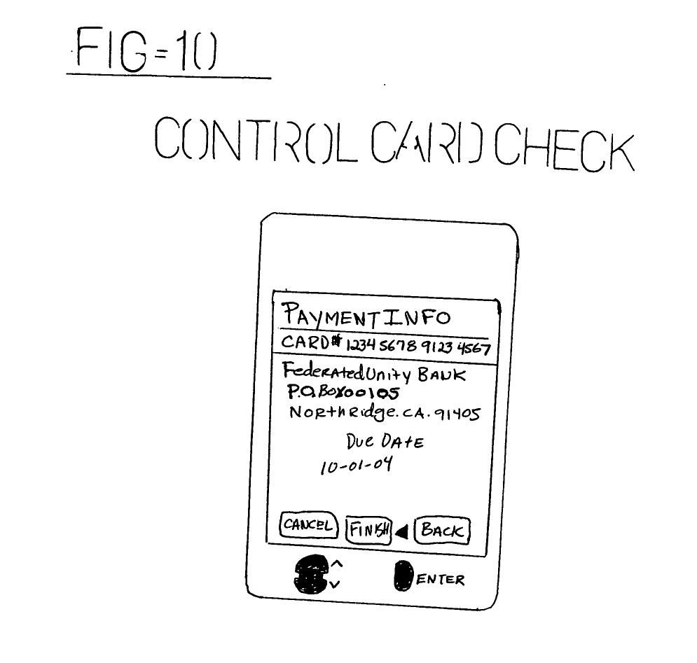

(FIG. 10) is a picture of option D from FIG. 6; PAYMENT INFORMATION. The screen displays the address and phone number of the bank to which the card corresponds. Here also view payment due date. Touch CANCEL at bottom left to cancel program and turn off system. Touch FINISH to end and start over, and check another card. Touch BACK at bottom right to go back to previous options.

### DETAILED DESCRIPTION OF THE INVENTION

The present invention provides a system and method for accessing individual financial records for bank and credit card customers by using a hand held wireless, digital device; much like a PDA device, but consisting of different technology matter which evolves the use of the existing software and hardware. The preferred embodiment consists of magnesium alloy and plastic to house the hardware, and the appropriate dimensions should be 0.37″L×2.37″W×3.68″H, and weighs approximately 5½ to 6 ounces, as shown on (FIG. 1), and mentioned in (claim 2).

First turn on device by using the on/off switch located on the upper right side, next to the screen; (FIG. 1). Following the maximum insertion of the users magnetic strip card to be inserted in to the portable card reader slot embedded inside the micro-controller; (FIG. 1) illustrates the top view of where the card slot reader is rooted. Also, (FIG. 3) illustrates in actual size, an example of a bankcard being inserted into the card reader slot in a downward motion. Materials inside the card reader consists of guiding rails to guide the edges of the card as it is being pushed inside; magnetic reader sensors, spring coils, and a locking switch that is supplied with a responsive release button; shown on (FIG. 1). Also, a Digital Signal Processor (DSP) chip is needed inside the embodiment, so that the analog to digital conversion signal can be enabled and output by process of modulation. Analog to digital conversion is an electronic process in which a continuously variable (Analog) signal is charged, without altering its essential content, into a multi-level digital signal. The input to analog-to-digital converter (ADC) consists of a voltage that varies among a theoretically infinite number of values. Examples are sine waves, the waveforms representing human speech, and the signal from a conventional television camera. The output of the ADC, in contrast, has defined levels or states. The number states is almost always a power of two-that is, 2,4,8,16, etc. The simplest digital signals have only two states, and are called binary. All whole numbers can be represented in binary form as strings of ones and zeros. Digital signals propagate more efficiently than analog signals, largely because digital impulses, which are well-defined and are in order, are easier for the electronic circuit to distinguish from noise, which is chaotic. This is the chief advantage of the digital modes in communications. Computers “talk” in terms of binary digital information; while a microprocessor (DSP) can analyze data, it must be converted into digital form for the computer to make sense of it. Then, a typical phone modem makes use of an ADC to convert the incoming audio from a twisted-pair line into signals the computer can understand. In a digital signal processing system, an ADC is required if the signal input is analog.

Once the data has been read from the back of the card (magnetic stripe), the DSP chip converts the analog to digital data that then transmits an identification code to the bank network (host processor) that recognizes the identification of the card; (Claim 2A. & 3). This is all possible by a modem that works together with and that would be ideal for satellite Global Systems for Mobile Communication (GSM) that is an international standard for backhaul and ISP trunking.

(FIG. 4) illustrates the flow of frequency waves that transmit the data back and forth using the same cell towers as cell phones use in order to find the GSM satellites that send frequency to host processor, that reads the data, then sends reply back to satellite, that then sends data directly to the initial controller (CONTROL CARD CHECK), but uses a different compressed WAV format (ADPCM) Adaptive Differential Pulse Code Modulation that is an audio compression scheme which compresses from 16 bit to 4 bit for a 4:1 compression ratio, as mentioned in (Claim 7 & 7A); making CONTROL CARD CHECK the evolution to personal financial auditing that is a feature no other pocket hand held device offers. In addition, cell phones and palm pilots can benefit from the present invention integration as shown in (FIGS. 2 & 2A), hypothetical examples. This micro- controller also needs and uses (FSK) frequency shift keys to send data back and forth over (AMPS) Advanced Mobile Phone Systems which make up part of the (GSM); also mentioned in (claim 6 & 6A). Frequency shift keys use the (ADPCM) WAV format scheme while modulation takes place.

A simple process called modulation makes this all possible with the use of a modem that is installed into the preferred embodiment. The interior wireless modem that (modulates & demodulates) conducts a communications process in which some characteristics of a wave is made to vary in accordance with an information-bearing signal wave. The demodulation process is when the original signal is recovered from the wave modulation; (Claim 8). Modulation achieved by the transfer of energy by oscillatory motion, preferred embodiment needs micro-oscillators, that is an electronic circuit that produces an output signal of a specific frequency, capable with quartz crystal oscillators generally consisting of micro-amplifiers having part of its output returned to the input by means of the feed back loop; (Claim 8A, 8B, 8C). The above mentioned is part of the modulation process that needs to work together with an integrated micro-mixer to translate signals upward or down ward in frequency; (Claim.9). In this case an integrated Polymer lithium battery would be ideal, because of its long duration of about 14 to 20 hrs depending on usage. These batteries are the same ones cell phone and PDA's use. In illustration (FIG. 1) the battery AC adapter recharge insert is evident underneath the embodiment.

The use of an integrated micro-potentiometer makes an exact determination of electromagnetic force that is derived from the battery; (Claim. 10). An interior antenna is also needed to facilitate the transmission or receiving of electromagnetic waves. The system operates on a high-speed processor, preferably supplied by an integrated Intel's® Strong Arm model.

After instant automatic modulation has been achieved, CONTROL CARD CHECK asks you to input your four-digit pin number for security purposes. This is to verify that the card is in the possession of the appropriate owner. (FIG. 5) is an illustration of a touch screen pad, (160×160) black and white transflective set-up, with the number arrangements alike to a telephone and ATM. Just touch your four-digit pin number, and then touch ENTER to continue. The ENTER button can also be used to continue. Touch CANCEL if a mistake is made. The process of modulation takes place again and grants you access to your account. In (FIG. 6.) a drawing of the four options are listed. Using the left bottom button to move you UP/DOWN, or touch the desired option on the screen, then touch ENTER to continue; or press the ENTER button.

(FIG. 7.) Depicts is the first option. Current balance. Here you can see your most recent Balance on the card. It may be possible to also view available balance, which may be different from current balance. Touch on the CANCEL to cancel, or CONTINUE to move to the second choice. (FIG. 8.) is the second choice, daily transactions made. Touch CONTINUE to move forward, BACK to choice one, or CANCEL to end audit. Bottom left button can move you up/down. (FIG. 9.) is similar to FIG. 8; the difference is that FIG. 9 is Weekly Transactions. Use the same steps as FIG. 8. to move you through. (FIG. 10.) is the last option. Payment Information with bank address and telephone number. Due date also listed. Touch CANCEL to finish and turn off system. Touch FINISH to end and start over, and check another card, or touch BACK to move to the previous option(s). The tools used to manufacture such a device are the same and similar to that used to build a Cell Phone and a handheld PDA.

It should be stated that the above-described embodiments of the present invention, principally, any “preferred” embodiments, are simply possible examples of the implementations, simply set forth for a clear understanding of the idea of the invention. Many variations and modifications may be made to the above embodiment of the invention without leaving significantly any forms and ideas of the invention. All such modifications and variations are intended to be included herein within the range of this disclosure and the present invention, and protected by the subsequent claims.

1) CONTROL CARD CHECK is a wireless, digital device with a system and method for accessing individual financial records for bank and credit card customers only, but not limiting the Cell Phone, PDA (palm pilot), or Lap-Top companies to integrate this invention into their products.

2) The user inserts their card into a portable magnetic stripe card reader slot operatively embedded inside the micro-controller with the dimensions: 0.37″L×2.37″W×3.68″H, and weighing approximately 5½ to 6 ounces.
(A) The card reader consists of parallel guiding rails on both sides of the sensor in order to guide the edges of the card consisting of an arrangement of sensors, spring coils, and the exercise of maximum insertion of the magnetic card into the slot; card reader, and pressing the springs and locking the switch that is supplied with a responsive button to release the card once the user is done using it. The sensors automatically scan the encryption code from the magnetic strip and agree with;
(B) a digital signal generator linked to the reader for producing a digital signal based upon the read signal; the digital generator outputs the (ADC) analog to digital conversion signal enabled by a Digital signal processor(DSP)chip.
(C) Analog to digital conversion is an electronic process in which a continuously variable (Analog) signal is charged, without altering its essential content, into a multi-level digital signal.

3) Transmitting an identification code to the bank network host processor that recognizes the Identification of the card through a modem that is ideal for satellite Global System for Mobile communications (GSM) backhaul and ISP trunking that is an international standard.

4) CONTROL CARD CHECK then asks you to input your four-digit pin number on the black and white, display touch screen (160×160) transflective in order to verify that the card is in the possession of the appropriate owner;
(A) Like lock numbers, Pin numbers are based on the rule of decoding and encoding of secret information;
(B) These numbers make up a code so people cannot access your account by any means of technology vehicles.

5) In relations to claim 3, CONTROL CARD CHECK has to connect to, and communicate through, a host processor, via point-to-point dedicated telegraph line;
(A) A host processor is analogous-(alike) to an Internet Service Provider (ISP) in that it is the gateway through which all the various ATM networks become available to the cardholder.
(B) Subsequent to claim 3, 6, and 6A, CONTROL CARD CHECK uses a narrow band that is 30 kHz wide and 6.7 millisecond long is a split time wise into three time slots. Narrow band means channels in the traditional sense. Data converts to digital information that is compressed so that it takes up significantly less transmission space than analog transmissions. This frequency is transmitted to a host processor that converts it back into a copy of the original information; then sends that information to the bank; the bank reads the data, recognizes it, then sends it back to the receiver (host processor) that mixes the codes of information, discerns it, and sends it back to the initial Modulator (CONTROL CARD CHECK).

6) CONTROL CARD CHECK relies on frequency-shift keying (FSK) to send data back and forth over (AMPS) Advanced Mobile Phone System. FSK uses two frequencies, one for 1s and the other for 0s, alternating rapidly between the two to send digital information between the cell tower and the modulator.
(A) Clever modulation and encoding schemes are required to convert the analog information to digital, compress it and convert it back again while maintaining an acceptable level of quality. All of this means that digital systems need to contain a lot of processing power.

7) In relations to claim 6A, a Wav format is needed. Microsoft's Compressed WAV format ADPCM (Adaptive Differential Pulse Code Modulation) is an audio compression scheme which compresses from 16-bit to 4-bit for a 4:1 compression ratio, or;
(A) Compressed WAV format. U-Law (or CCITT standard G.711) is an audio compression scheme and international standard in telephony applications. U-Law is very similar to A-Law, a variation of u-Law found in European systems. This encoding format compresses 16-bit audio down to 8 bits (for a 2:1 compression ratio) with a dynamic range of about 13-bits. Thus, u-Law encoded waveforms have a higher s/n ratio than 8-bit PCM, but at the price of a bit more distortion than the original 16-bit audio. The quality is higher than you would get with 4-bit ADPCM formats. Encoding and decoding is rather fast and generally, widely supported.

8) In relations to claim 3,5,5A, and 5B, an interior wireless modem (modulator/demodulator) conducts a process of modulation; a communication process in which some characteristics of a wave is made to vary in accordance with an information-bearing signal wave. Demodulation is processed by the original signal recovered from the wave produced by modulation.
(A) Modulation achieved by the transfer of energy by oscillatory motion, either of some material medium or by the variation in magnitude of the field vectors of an electromagnetic field transmitting and receiving digital data over a communication line normally used for analog signals;
(B) As mentioned in claim 8A, a micro-Oscillator=electronic circuit produces an output signals of a specific frequency, capable with quartz crystal oscillators generally consisting of;
(C) Micro-Amplifiers having part of its output returned to the input by means of a feedback loop.

9) A Micro-mixer to translate signals upward or downwards in frequency.

10) A Micro-Potentiometer makes a precise determination of electromagnetic force, or maximum output voltage, of a cell generator (battery) by comparing it with a known voltage.

11) Initialize Memory location in the device in order to receive a stream of data from each lined sensor in the card reader.

12) The screen gives you four options to choose from.
A. Current Balance.
B. Daily transactions
C. Weekly transactions
D. Payment information and Due date. (Bank payment address & phone numbers).

13) Two buttons; left one is for up/down, and the right button is for enter. Audit your account.

14) Network frequency: 900/1900 MHz GSM, and any other Mobile satellite network systems.

15) (1500 mAh Li-Lon) battery (rechargeable).

16) Interior antenna

17) Housing material consists of Magnesium Alloy and Plastics.

18) Signal pulses can be read using the computer software of an existing conventional card reader; or the language program can be created and manipulated anew. Microsoft® Windows embedded preferred.

19) Intel® Strong Arm 144 MHz processor, or higher (if needed).
